(19) United States
(12) Patent Application Publication
(10) Pub. No.: US 2025/0022340 A1
(43) Pub. Date: Jan. 16, 2025

(54) DYNAMIC CONTROL OF GAME FLOOR LIGHT EMISSION AND GAME ENVIRONMENT DURING LIVE SPORTING EVENT

(71) Applicant: Project Fanchise Technology LLC, Hermosa Beach, CA (US)

(72) Inventors: Steven ADLER, San Diego, CA (US); Sohrob FARUDI, Temecula, CA (US); Aaron CASILLAS, Las Vegas, NV (US); Cyrus FARUDI, Boulder, CO (US); Patrick DEES, Temecula, CA (US); Grant COHEN, Los Angeles, CA (US)

(21) Appl. No.: 18/742,963

(22) Filed: Jun. 13, 2024

Related U.S. Application Data
(60) Provisional application No. 63/513,437, filed on Jul. 13, 2023.

(51) Int. Cl. G07F 17/32; A63F 13/332; A63F 13/86; H04N 21/2187; H04N 21/478

(52) U.S. Cl. CPC G07F 17/3239; A63F 13/332; A63F 13/86; H04N 21/2187; H04N 21/4781

(57) ABSTRACT

A system has a multi-layer structure having a playing surface upon which players participate in a sporting event. The multi-layer structure includes an arrangement of illumination elements configured to controllably emit light. The arrangement of illumination elements is separated by a gap from a substantially transparent layer supporting the playing surface. A player tracking subsystem includes sensors configured to provide detection signals useable to track locations of one or more of the players relative to the playing surface. A control subsystem is configured to control operation of the arrangement of illumination elements responsive to the locations of the one or more of the players and to gain status information relating to the sporting event.

### CROSS-REFERENCE TO RELATED APPLICATION

This application claims priority to U.S. Provisional Patent Application 63/513,437, filed Jul. 13, 2023, the contents of which are incorporated herein by reference.

### TECHNICAL FIELD

The present disclosure generally relates to floor structures used as courts or playing surfaces for sporting events and, more particularly, to court floors configured to emit light.

### BACKGROUND

Floors or other surfaces upon which athletic competitions are played may be stained or painted to display certain markings or designs. For example, the wood floor of a basketball court has painted lines to define court boundaries and may also be marked with team logos, advertisements, or other designs. However, it is generally time consuming and expensive to change the lines or other designs painted on wood courts, and in some cases, this is simply infeasible. Moreover, if lines defining more than a single court size or type are painted on the floor the result can be confusing to both fans and players.

Lighting is typically utilized in arenas or other venues containing courts or other playing surfaces in order to illuminate some or all of the playing surface. Such illumination may highlight or otherwise draw attention to particular players or to markings on the floor (e.g., logos or advertisements). However, although spotlights and other existing forms of illumination can accent floor areas of interest, such conventional illumination sources are not capable of accurately defining boundary lines or the like on game floors or courts. Such conventional lighting is also generally insufficiently precise to render logos, advertising, or other information on the floor surface.

Recently, various proposals have been made for providing a floor assembly configured to emit light. For example, one proposal contemplates providing an arrangement of electronic display screens (e.g., display panels) below one or more transparent covering layers positioned above the electronic display screens. However, the use of electronic display screens for illumination purposes may be costly and may limit the brightness and clarity of content rendered through the game floor.

### SUMMARY

A system has a multi-layer structure having a playing surface upon which players participate in a sporting event. The multi-layer structure includes an arrangement of illumination elements configured to controllably emit light. The arrangement of illumination elements is separated by a gap from a substantially transparent layer supporting the playing surface. A player tracking subsystem includes sensors configured to provide detection signals useable to track locations of one or more of the players relative to the playing surface. A control subsystem is configured to control operation of the arrangement of illumination elements responsive to the locations of the one or more of the players and to gain status information relating to the sporting event.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram illustrating a system for dynamically controlling a game environment of a live sporting event, in accordance with an embodiment.

FIGS. 2A and 2B depict a system for dynamically controlling a game environment of a live basketball game in accordance with an embodiment.

FIG. 3 is a cross-sectional view of an embodiment of a multi-layer floor of a basketball court as configured with selectively illuminable court areas and markings.

FIG. 4 illustrates a rectangular polycarbonate section included within a polycarbonate layer of a multi-layer floor in accordance with the disclosure.

FIGS. 5A and 5B illustrate components included within an exemplary implementation of an LED frame structure included within a layer of the multi-layer floor.

FIG. 6 is a partially disassembled and perspective view of various elements of a multi-layer floor in accordance with the disclosure.

FIG. 7 illustrates a portion of a multi-layer floor when illuminated so as to render an exemplary basketball court.

FIG. 8 is a flow chart describing an exemplary method carried out by the game environment control platform for adjusting or activating parameters of an illuminable game floor in response to input provided by user devices.

FIG. 9 illustrates an exemplary configuration for leveraging Automatic Content Recognition (ACR) in determining a Time Behind Live (TBL) parameter applicable to viewing of live game action on a second screen device rather than through a user application executing on a primary user device.

FIG. 10 is a flow chart describing an exemplary method for determining TBL in using the configuration of FIG. 9 in the case in which clocks on an ACR server and on a user device are not synchronized.

### DETAILED DESCRIPTION

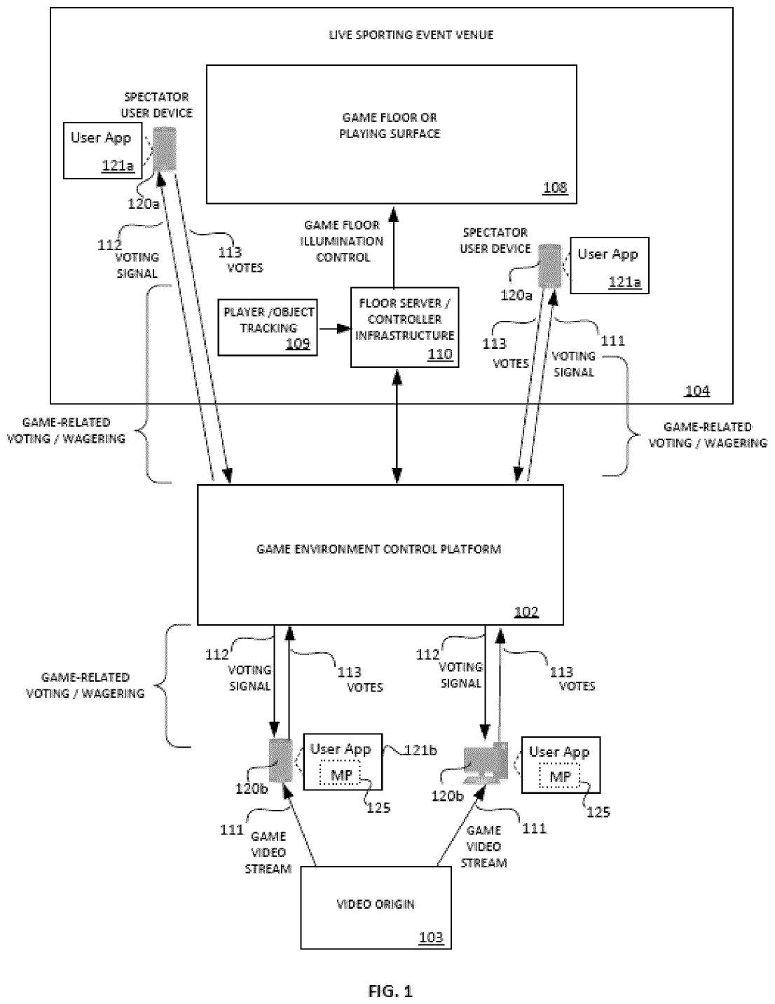

FIG. 1 is a block diagram illustrating a system 100 for dynamically controlling a game environment of a live sporting event, in accordance with an embodiment. In examples described herein, the system 100 allows viewers of a sporting event to participate in control of a game environment for a live sporting event. Examples of live sporting events in which implementations of the system 100 may be utilized include, for example and without limitation, basketball, ice hockey, futsal, American football and the like. In various aspects, through the use of the system 100, viewers can provide input (e.g., votes) regarding various decisions pertaining to dynamically modifiable parameters or conditions pertinent to playing of a live sporting event. For example, in the game of basketball these parameters could affect, for example, the distance of the three-point line from the basket during various time periods in the game whether baskets made by selectively activated players or from selectively highlighted court areas result in the award of a greater number of points, etc. In addition, the system 100 can dynamically and selectively illuminate portions or area of the playing surface associated with a bonus parameters pertinent to the sport being played, track players and/or balls during game play and illuminate corresponding areas of the playing surface, play videos, render dynamic 2D and/or 3D graphics, synchronize the content of other displays within the game venue to illumination of the playing surface, and synchronize audio within the venue to the changes in the illumination of the game playing surface. As is discussed below, in exemplary embodiments the game playing surface is illuminated utilizing light emitting devices incorporated within the game court, field or other platform upon which the live sporting event is conducted.

In various embodiments the system 100 may be configured not only to control game parameters of the live sporting event and other aspects of the game environment but may also facilitate real-time or other wagering by viewers of the sporting event. Such wagering may be with respect to, for example, the outcome of game plays executed during the sporting event, the occurrence of predefined events during the sporting event, and the game performance of selected players.

As shown in FIG. 1, the system 100 includes a game environment control platform 102 configured to control aspects of the environment within venue 104 hosting a live sporting event. The venue 104 includes a game floor or playing surface 108 upon which the live sporting event is being played. As is described hereinafter, the game floor or playing surface 108 may incorporate a transparent playing surface overlying illumination elements (e.g., light emitting diodes, “LEDs”) arranged in a grid-like configuration. Floor server/controller infrastructure 110 in communication with the game environment control platform 102 may be configured to selectively illuminate the illumination elements within the game floor or playing surface 108 so as to render content viewable by spectators within the live sporting event venue 104 or viewers of a video stream 111 or broadcast of the live sporting event. The content rendered by the floor illumination elements may be influenced or selected based upon user input (e.g., voting) received by the control platform 102 from user devices 120a of spectators within the venue 104 and/or user devices 120b of viewers of a live steam or broadcast of the live sporting event. The user devices 120 may execute user applications 121 configured to receive the user input conveyed to the platform 102. The user applications 121b executed by user devices 120b external to the venue 104 will typically include or be linked to media players 125 configured to render the video stream 111. Certain user devices 120 (e.g., personal computers) may receive user input via, for example, a Web browser configured to communicate with the platform 102. The video stream 111 may be streamed by a video origin 103 which may comprise, for example, a cloud-based platform configured to generate the video stream 111 from one or more video feeds produced by one or more video cameras (not shown).

In one embodiment the control platform 102 may regularly poll the user applications 121 by sending a voting signal 112 to solicit votes 113 relating to parameters of the live sporting event being played on the game floor or playing surface 108 which could be adjusted through selective illumination of portions of the game floor 108. Based upon the results of polling of the user applications 121 the control platform 102 may provide instructions or configuration information to the floor server/controller infrastructure 110 regarding illumination of selected portions of the game floor or playing surface 108. For example, portions of the game floor or playing surface 108 could be selectively illuminated at predetermined floor locations in order to, for example, toggle “bonus areas” or the like on and off during the sporting event. Players of the sporting event within active bonus areas could be awarded a greater number of points in connection with positive game outcomes. For example, a greater number of points could be awarded to the team of a player when the player makes a shot or goal from one of the bonus areas relative to the case in which the player is not within one of the bonus areas. Other positive player actions within an illuminated bonus area could also result benefits accruing to the player's team (e.g., additional “time outs” being awarded).

The instructions or configuration information provided by the control platform 102 to the floor server/controller infrastructure 110 need not be limited to information resulting in a change of playing parameters of the live sporting event and need not be in response to user input provided to the user devices applications 121. For example, advertising content, videos, player/game statistics, animations or the like could be provided by the control platform 102 to the floor server/controller infrastructure 110 for rendering by the illumination elements of the game floor or playing surface 108 during the game and/or during breaks in the playing of the live sporting event (e.g., during time out periods, between game periods (quarters/halves), etc.). Similarly, the control platform 102 could provide graphical content to the floor server/controller infrastructure 110 for rendering by the illumination elements of the game floor or playing surface 108 in response to game events (e.g., following a scoring event or other key play).

In addition, the control platform 102 may instruct the floor server/controller infrastructure 110 to cause the illumination elements within the game floor or playing surface 108 to display content associated with the location and/or movement of players and/or game objects relative to the playing surface 108. Such location or movement information may be provided to the floor server/controller infrastructure 110 by a player/object tracking module 110 configured to track players and/or game objects (e.g., game balls) during game play on the playing surface 108. Such tracking may be effected by, for example, attaching radio frequency (RF) tags to the players and/or game objects and deploying antennas (not shown in FIG. 1) proximate the game floor or playing surface 108 to detect signals emitted by the RF tags affixed to the players and/or game objects or deploying cameras (not shown in FIG. 1) proximate the game floor or playing surface 108 to gather video of the players and/or game objects and analyzing the collected videos. Information relating to the detected RF signals is provided by the antennas to the player/object tracking module 109, which triangulates positions of the tagged players and/or game objects in an (x, y, z) coordinate space. In one embodiment the (x, y) locations within the (x, y, z) coordinate space are mapped to (x, y) locations on the game floor or playing surface 108 by the floor server/controller infrastructure 110. This enables the floor server/controller infrastructure 110 to generate associated graphical content for display by illuminable portions of the game floor or playing surface 108 based upon the locations of the tagged players and game objects on the game floor/surface 108. Such associated graphical content could comprise, for example, a “cursor” surrounding the player and/or game object and/or a “trail” of illumination behind a moving tagged player or game object. The “z” values within the triangulated (x, y, z) coordinates of the players/game objects may either be ignored by the floor server/controller infrastructure 110 or, alternatively, used by the floor server/controller infrastructure 110 in influencing aspects of the graphics (e.g., other animations/graphics, color, brightness, etc.) displayed by the floor 108 in association with players or game objects.

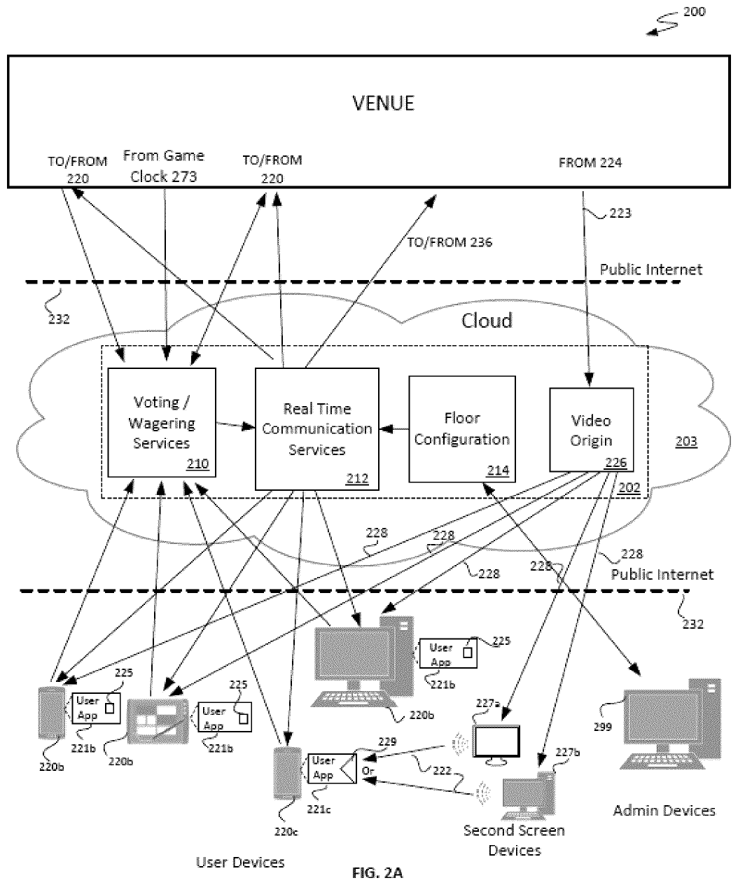

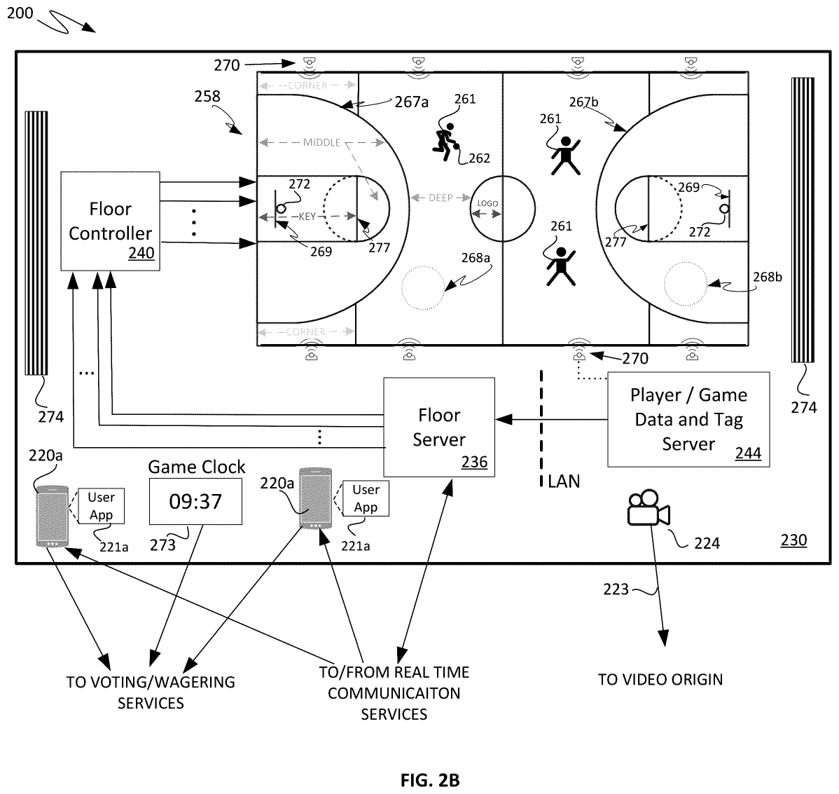

Attention is now directed to FIGS. 2A and 2B, which depict a system 200 for dynamically controlling a game environment of a live basketball game in accordance with an embodiment. As shown in FIG. 2A, the system 200 can include a cloud-based game environment control platform 202 having a voting/wagering services module 210, a real-time communication services module 212 and a floor configuration module 214. The voting/wagering module 210 and the real-time communication services module 212 communicate with user devices 220b external to a venue 230 within which the basketball game is conducted and with user devices 220a internal to the venue 230, which is shown in greater detail in FIG. 2B. This communication between the services modules 210, 212 and the user devices 220 may be over one or more networks including the Internet 232. The user devices 220 preferably execute or run user applications 221 configured to receive user input which may be conveyed to the services modules 210, 212. The user applications 221 render content provided by the services modules 210, 212. The user applications 221b executed by user devices 220b external to the venue 230 will typically include media players for rendering a live stream 228 of the basketball game being played on the game floor 258. The live stream 223 may be generated by a video workflow 224 disposed within the venue 230 and provided 228 to the user devices 220b by video origin module 226.

In one embodiment the floor server 236 generates floor illumination information provided to a floor controller 240 in response to multiple sources of input information. For example, the floor server 236 may receive (i) the floor configuration information generated by the floor configuration module 214, (ii) information from server 244, such information including player/game data and statistics and player/object position data (described below) collected and electronically stored by observers of a game being played on a game floor 258 or by automated collection methods, (iii) positional data provided by a player/game data and tag server 244 which identifies the locations of players 261 and game elements 262 (e.g., a game ball) on the game floor 258, and (iv) results of polling of the user applications executed by the user devices 220. Based upon the illumination information provided by the floor server 236, the floor controller 240 controls illumination elements (e.g., light emitting diodes (“LEDs”)) within the game floor 258. Although in the embodiment of FIG. 2B the game floor 258 is a basketball court, in other embodiments the game floor 258 may comprise a court or playing surface for another sport (e.g., futsal), an ice hockey rink, or other illuminable playing floor.

In one embodiment the players 261 and one or more game element(s) 262 are tagged with radio frequency tags or other tags capable of being detected by antennas 270 (or, alternatively, tag readers) located proximate the game floor 258. The signals produced by the tags on the players 261 and game elements 262 are provided to the player/game data and tag server 244. In one embodiment the player/game data and tag server 244 processes the tag signals received by the antennas 270 and triangulates positions of the players 261 and game elements 292 in an (x, y, z) coordinate space. The triangulated (x, y, z) positions of the players 291 and game elements 262, along with game time information provided by a game clock 273, may then be broadcast by the player/game data and tag server 244 and received by the floor server 236. In one embodiment the (x, y) locations within the (x, y, z) coordinate space are transformed by the floor server 236 to (x, y) locations on the game floor 258. This enables the floor server 236 to generate graphics for display by illuminable portions of the game floor 258 (which may be the entire game floor 258) based upon the locations of the players 261 and game elements 262 on the game floor. The “z” coordinates of the players 261/game elements 262 within the (x, y, z) coordinates broadcast by the player/game data and tag server 244 may either be ignored by the floor server 236 or, alternatively, used by the floor server 236 in generated graphics associated with one or both of selected players 261 and game elements 262. For example, the floor server 236 may generate graphics which cause portions of the game floor 258 underneath and slightly behind a given player 261 deemed by game logic executed by the floor server 236 to be active (e.g., a player 261 in possession of a game element 262 such as a game ball) to be illuminated as the player 261 moves across the game floor 258. When the player 261 jumps, the “z” coordinate of the player will change and this change may result in a change in the graphics generated by the floor server 236 associated with such player 261 (e.g., the graphical content could change in intensity, color, shape, etc. as function of the detected “z” value). Similar changes could be made in any graphical content generated by the floor server 236 for display by the game floor 258 based upon the “z” coordinate of the game elements 262.

In one embodiment the real time communication services module 212 may regularly poll user applications executed by the user devices 220 to solicit votes relating to parameters of the basketball game being played on the game floor 258 which could be adjusted through illumination of portions of the game floor 258. For example, the user applications executed by the user devices 220 could provide votes or other input relating to activations and corresponding illumination of “bonus areas” 268 or other areas on the game floor 258. In one embodiment basketball shots taken by players 261 located within bonus areas 268 would be awarded “bonus points” if successful than successful shots taken from other areas on the game floor (e.g., other areas within a three-point line 267). The number of bonus points awarded by for each successful shot from an activated bonus area may be configured and changed in real time via an admin device 299 and subsequently communicated to the floor configuration module 214. In one embodiment the precise location of the bonus areas 268 is provided to the real time communication services module 211 by the floor configuration module 214, which in turn communicates the locations of the bonus areas 268 to the floor server 236 over one of more networks including the Internet 232.

As another example, fans may vote on a player to be activated, or “lit”. When a player is “lit”, the player is followed with graphics generated by the game floor 258 for the duration of the player's lit status. For every shot that player makes, bonus points are awarded, and the number of bonus points are configurable as are the points for bonus areas. If a lit player shoots successfully from an activated bonus area/zone (a “lit zone”), then the player receives the bonus points for themselves and the zone.

In one embodiment these votes for lit zones and players occur repetitively throughout a game period based on a configurable timer. For example, a zone could be lit for 2 minutes and during that period the users are voting for the next lit zone. The same approach could be used with respect to voting for lit players. Voting for lit zones and lit players may be staggered or concurrent.

In another embodiment, the possible bonus areas encompass the entirety of each offensive half of the court. In this embodiment each half court is divided into five (5) shooting “zones”, each of which corresponds to a bonus area. In FIG. 2B these bonus areas are labeled CORNER, MIDDLE, KEY, DEEP and LOGO.

In one embodiment the floor server 236 generates graphical content associated with active game objects (e.g., players 261 and/or game elements 262 deemed active by the game logic). The floor server 236 provides this content to the floor controller 240, which causes the game floor 258 to repetitively render such content in manner that indicates state and motion of such active game objects. In general, such object graphics (i.e., graphical content rendered by the game floor 258 and associated with an active game object) change state based on location, velocity, distance from floor and other game-related events. For example, in the case of basketball such game-related events could comprise a player dribbling, the making of a basketball shot, the blocking of a basketball shot, a “slam dunk”, an alley-oop. a basketball shot which hits the rim of the basket 272 but does not go in the basket (i.e., a “bricked” shot) and so on.

In one embodiment the floor server 236 may be configured to generate instructions for control of illumination of illuminable structures within the venue 230 other than the game floor 258. For example, in one embodiment transparent or semi-transparent basketball backboards 269 at either end of the basketball court on game floor include LEDs under the control of the floor controller 240 or a separate controller unit. The LEDs may be arranged in a grid-like pattern behind, and affixed to, each basketball backboard 269 so as to enable rendering of arbitrary graphical content. In one embodiment the LEDs behind each backboard 269 render graphical content which is complementary to the content rendered by the game floor 258. For example, the LEDs behind the backboard 269 coupled to the basket 272 through which a basketball shot by a player 261 is made may render content (e.g., one or more flashing colors or other graphics) synchronized with similar content rendered by the game floor 258 upon making of the shot. One or both of the game floor 258 and backboard(s) 269 could also be configured to render statistical information upon the making of a basketball shot (e.g., total points scored by the player 261 making the shot, player shooting percentage, etc.). One or more electronic displays 274 within the venue 230 could also be configured to be controlled by the floor controller 240 or some other controller not shown here and could be utilized to render graphical or other content similar or complementary to the content rendered through the game floor 258 or backboard(s) 269. In addition, audio content could be produced by speakers (not shown) in coordination with video content or imagery being rendered by the game floor 258, backboard(s) 269 and/or other electronic displays 274.

As noted above, the voting/wagering services module 210 receives votes or other inputs from user devices 220 and determines which bonus areas 268, if any, and/or other areas of the game floor 258 are to be illuminated or driven by the floor controller 240 to render content based upon such votes or other inputs. In one embodiment these votes, or other user input is weighted by the module 210 based, at least in part, on respective rankings of users of the user devices 220. Rankings can be bound to the user's account (e.g., points accumulated, level attained, badges held, etc in any combination) and/or to some digital object that the user possesses, and which may be sold, traded or given to other users. In some examples, a number of users of the user devices 220 can be chosen (e.g., based on their respective rankings) to perform enhanced roles or be accorded enhanced voting rights in one or more processes affecting illuminable parameters of the game floor 258.

In some examples, the module 210 computes a metric or a score for each of the users of the user devices, the score being used to rank users of the user devices 220 and thereby assign a respective weight to each users' input. The score of a given user can vary depending on how the particular user votes relative to other users with respect to illumination of various illuminable areas of the game floor 258. For example, users of the user devices 220 may be polled by the module 210 with regard to whether certain floor “bonus” areas (i.e., areas in which greater points are awarded for made shots) should be activated. As another example, users of the user devices 220 affiliated with a given team may be polled as to whether the three-point shot line in the front court of an opposing team should be moved through appropriate adjustment of the illumination of the game floor 258. If the particular user consistently votes to activate areas of the game floor 258 or to move court boundaries through adjustment of the illumination of the game floor 258 that are ultimately activated or moved, the particular user may be awarded points, or “Fan IQ”, which commensurately increases the user's score and level. Alternatively, or in addition, the score of a given user could instead be affected by votes cast by the user relative to the votes of other users with respect to various other aspects of the basketball game being played on the game floor 258. For example, a user's vote, relative to the votes of other users, as to whether a team affiliated with the users should attempt more 3-point could influence the score of the user. Similarly, votes by the user, relative to votes by other users, as to whether an affiliated team should substitute a given player for another player, or make a defensive change, etc., could also influence the score of the user. In one embodiment the score of a user of a user device 220 will be increased when the user casts a vote in agreement with the votes of a majority of other users of devices 220. In another embodiment, all users participating in a game by voting to activate areas of the game floor 258, activate players 261, determine player 261 substitutions and/or participate in other interactive game activities in the user app 221, would have their score increased every time a player 261 on their team scores points.

In general, the results of polling of the user devices 220 may result in a number of different events affecting game play on the game floor 258. For example, players may be “lit” in the manner discussed above as a result of user polling. A game ball could also be “lit” based upon user polling (e.g., a special graphic could be generated by the game floor under the ball). When a game ball is lit, every made shot could yield bonus points. More generally, the results of the polling of user devices 220 may cause the floor server 236 to generate signals resulting in illumination of the areas 268 or of other areas of the game floor 258 proximate (e.g., underneath) players 261 or game objects 262 being tracked in order to modify the game scoring associated with such areas 268, objects 262 or players 261. The floor server 236 may also, based upon the results of such polling, generate signals specifying substitution of one player 261 for another player, block the opposing team's substitution of one player 261 for another player, reduce the size (i.e., number of players) of an opposing team, block execution an attempt by user of user devices 220 affiliated with an opposing team to activate (i.e., illuminate) a floor area 268, and the like.

In certain implementations the voting module 210 receives user input from selected user devices 220. Selected users can be a selected number (e.g., five or ten) users who are chosen to have greater involvement in the determination of decisions affecting illumination of the game floor 258. The selected users can be chosen based on, for example, their respective scores or digital items they possess.

In certain implementations, the real time communication services module 212 receives live game data generated by, for example, a statistics server configured to produce game-related statistics based upon game play occurring at the venue 230. Such live game data may include game statistics such as, for example, a current score of the game, a time remaining in the game or period, that a basketball shot was made from a selectively activated (e.g., illuminated) area 268 of the court 258, that points were scored by a selected player 262, etc.

The real time communication services module 212 may regularly poll user applications 221 executed by the user devices 220 to solicit votes relating to parameters of the basketball game being played on the game floor 258 which could be adjusted through illumination of portions of the game floor 258. In one embodiment, during each configurable polling period (e.g., every 2 minutes) a polling or vote signal is sent by the voting/wagering services module 210 to some or all of the communication devices 220 via the real time communication services module 212. For example, during each polling period a polling signal may be sent to the user devices 220 owned or controlled by users affiliated with a given team comprised of players 261 (e.g., fans of a given team).

The users of user devices 220a outside the venue 230 view the game being played on the game floor 258 either by viewing the live video stream 223 as rendered by the media player 225 included within or linked to the user application 221b on their respective device 220b or by viewing the live video stream 223 as rendered on a second screen device 227 and enabling second screen watching mode in the user app 223 on their user device 220. This presents a number of challenges with respect to uniformly presenting, within each user application 221b and 221c, voting-related user interfaces associated with certain game events at the appropriate instant during rendering of the live video stream 223 by the media players 225. For example, because of differences in network bandwidth, latency, and the like, different user devices 220 will render the same frame of video information in the live video stream 223 at different times. This “time behind live” (TBL) is defined as:

$$T B L = {time}_{fan} - {time}_{venue}$$

where timeᵥₑₙᵤₑ refers to the time at which a particular item of video content is encoded for network distribution in the venue 230 and time_{fan} denotes the time at which the same item of video content is rendered by a given media player 225. The TBL can vary between devices 220 and can vary over time for a single device 220. This makes it difficult to synchronize user voting with respect to a given game event occurring on the game floor 258 since the users of different user devices 220b will view the game event via their respective media player 225 at different times and the users of different second screen devices 227 will view the game event via their respective second screen device at different times. Another problem in achieving synchronized voting with respect to fast moving game play on the game floor 258 is that conventional media players 225 (e.g., HLS players) may buffer many seconds worth of information (e.g., up to 3 HLS “segments” which could correspond to 18 seconds or more) before initiating playback. As a consequence, the use of such media players 225 within or by the user applications 221 would preclude voting on various game events when a relatively quick polling process is required (e.g., a polling process which needs to be completed by the user within a 10-15 second configurable time window in a given game event).

In order to effectively reduce the duration of video data within the live stream 228 that is buffered during operation of the media players 225, each user application 221b cooperates with the platform 202 to modify the manner in which its respective media player 220 obtains video content included within the live stream 228. As is discussed below, in one embodiment this involves configuring each user application 221b to intercept playlist-related calls made by its associated media player 225 in order to retrieve media stream content. The intercepted calls may then be rewritten and employed to retrieve video stream content in such a way as to reduce the duration of the video content buffered by each media player 225.

An example of such an approach for reducing the duration of video content buffered by each media player 225 will now be described with reference to implementations utilizing HTTP Live Streaming (HLS) players. Such HLS players are configured to render a live video stream comprised of .ts video segment files. The tag EXT-X-TARGETDURATION in an HLS media playlist, which is defined by the HTTP Live Streaming (HLS) RFC (https://www.rfc-editor.org/rfc/rfc8216.html #section-4.3.3.1), specifies the maximum Media Segment duration in seconds of the .ts video segment files. In one embodiment the live stream 228 may be generated by the video origin server 226 such the maximum segment duration of the ts video files is 2 seconds; however, even in this case the video origin server 226 sets the value of the EXT-X-TARGETDURATION tag in the playlist files to 6 seconds. This is problematic, since most conventional media players 225, such as HLS media players, will buffer up to three times the value of EXT-X-TARGETDURATION before playing video to avoid video playback stalling and/or spinners. In the case of a media player 225 comprised of an HLS player where EXT-X-TARGETDURATION is 6 seconds, the media player 225 buffers 18 seconds of video before playing video. Thus, a viewer of the application 221 starts out up to 18 seconds behind the live game within the venue 230. This would preclude the vast majority of viewers from being able to vote on time critical events within the game, since their votes would not arrive until after a vote tally had been completed within a voting window of 10-15 seconds from a game event triggering the vote.

Unfortunately, the EXT-X-TARGETDURATION parameter may not be directly reduced to 2 seconds without control of generation of the video stream 228, which in many applications is not possible. Accordingly, in accordance with one aspect of the present disclosure the playlist files associated with the live stream 228 are post-processed before reaching the media player 225 so as to enable the value of EXT-X-TARGETDURATION to be changed, With the value of this parameter changed to 2 seconds, the applicable media player 225 would only buffer 6 seconds of video before playing, which is an acceptable TBL to facilitate essentially real-time voting through user applications 221 based upon game events.

In one embodiment this post-processing is affected by registering custom URL (aka protocol) schemes for the media players 225. In the case of media players implemented as HLS players, see https://developer.apple.com/documentation/xcode/defining-a-custom-url-scheme-for-your-app regarding custom URL schemes available for iOS devices. Specifically, the original URL for the Master (or Multivariant) playlist, which contains the URLs for all of the bitrate variants for the live stream (copies of the same live stream at different resolutions, bitrates audio encodings, etc), is intercepted and the https protocol designator of the form:
https://multiplatform-f.akamaihd.net/i/multi/<some-path>/<video-name>.m3u8 is changed to the custom protocol masterproxy designator as follows.
masterproxy://multiplatform-f.akamaihd.net/i/multi/<some-path>/<video-name>.m3u8. The above rewritten URL is then passed to the media player 225.

When the media player 225 starts to play a stream 228, it makes a REST call to the video origin server 226 to retrieve the Master playlist. At this time, a custom URL scheme handler masterproxy executed by the iOS user device 220b gets called to handle the URL. The masterproxy handler then makes a REST call the video origin server 226 to retrieve Master playlist file, which looks like this:

#EXTM3U
#EXT-X-STREAM-INF:PROGRAM-
ID=1,BANDWIDTH=464000,RESOLUTION=640x360,CODECS=“avc1.77.30,
mp4a.40.2”, CLOSED-CAPTIONS=NONE
https://multiplatform-f.akamaihd.net/i/multi/<some-path>/<video-
name>_,640x360_400,640x360_700,640x360_1000,950x540_1500,.f4v.csmil/index_0_a
v.m3u8
#EXT-X-STREAM-INF:PROGRAM-
ID=1,BANDWIDTH=764000,RESOLUTION=640x360,CODECS=“avc1.77.30,
mp4a.40.2”, CLOSED-CAPTIONS=NONE
https://multiplatform-f.akamaihd.net/i/multi/ some-path>/<video-
name>_,640x360_400,640x360_700,640x360_1000,950x540_1500,.f4v.csmil/index_1_a
v.m3u8
#EXT-X-STREAM-INF:PROGRAM-
ID=1,BANDWIDTH=1062000,RESOLUTION=640x360,CODECS=“avc1.77.30,
mp4a.40.2”, CLOSED-CAPTIONS=NONE

The masterproxy handler then rewrites the URLs in the Master playlist file for the bitrate variants to use another custom protocol, variantproxy. The rewritten Master playlist file looks like this:

#EXTM3U
#EXT-X-STREAM-INF:PROGRAM-
ID=1,BANDWIDTH=464000,RESOLUTION=640x360,CODECS=“avc1.77.30,
mp4a.40.2”, CLOSED-CAPTIONS=NONE
variantproxy://multiplatform-f.akamaihd.net/i/multi/<some-path>/<video-
name>_,640x360_400,640x360_700,640x360_1000,950x540_1500,.f4v.csmil/index_0_a
v.m3u8
#EXT-X-STREAM-INF:PROGRAM-
ID=1,BANDWIDTH=764000,RESOLUTION=640x360,CODECS=“avc1.77.30,
mp4a.40.2”, CLOSED-CAPTIONS=NONE
variantproxy://multiplatform-f.akamaihd.net/i/multi/ some-path>/<video-
name>_,640x360_400,640x360_700,640x360_1000,950x540_1500,.f4v.csmil/index_1_a
v.m3u8
#EXT-X-STREAM-INF:PROGRAM-
ID=1,BANDWIDTH=1062000,RESOLUTION=640x360,CODECS=“avc1.77.30,
mp4a.40.2”, CLOSED-CAPTIONS=NONE

When the media player 225 selects the bitrate variant to play, it makes another REST call to retrieve that bitrate variant's playlist. At this time, the custom URL scheme handler variantproxy executed by the user application 221b on the user device 220b gets called to handle the URL. The variantproxy handler then makes a REST call the video origin server 226 to retrieve variant playlist file, which has an EXT-X-TARGETDURATION value of 6 seconds and looks like this:

EXTM3U
#EXT-X-VERSION:3
#EXT-X-TARGETDURATION:6
#EXT-X-MEDIA-SEQUENCE:0
#EXT-X-TWITCH-ELAPSED-SECS:32298.000
#EXT-X-TWITCH-TOTAL-SECS:32304.006
#EXT-X-START:TIME-OFFSET=0.000
#EXT-X-PROGRAM-DATE-TIME:2022-04-28T03:01:13.424Z
#EXTINF:2.002,Amazon|2474283100401
https://video-edge-da0548.hou01.abs.hls.ttvnw.net/v1/segment/C0yMMsD.ts
#EXT-X-PROGRAM-DATE-TIME:2022-04-28T03:01:15.426Z
#EXTINF:2.002,Amazon|2474283100401
https://video-edge-da0548.hou01.abs.hls.ttvnw.net/v1/segment/QtMjDLAw.ts

The variantproxy then rewrites the value of EXT-X-TARGETDURATION as 2 seconds and passes the modified playlist file to the media player:

#EXTM3U
#EXT-X-VERSION:3
#EXT-X-TARGETDURATION:2
#EXT-X-MEDIA-SEQUENCE:0
#EXT-X-TWITCH-ELAPSED-SECS:32298.000
#EXT-X-TWITCH-TOTAL-SECS:32304.006
#EXT-X-START:TIME-OFFSET=0.000
#EXT-X-PROGRAM-DATE-TIME:2022-04-28T03:01:13.424Z
#EXTINF:2.002,Amazon|2474283100401
https://video-edge-da0548.hou01.abs.hls.ttvnw.net/v1/segment/C0yMMsD.ts
#EXT-X-PROGRAM-DATE-TIME:2022-04-28T03:01:15.426Z
#EXTINF:2.002,Amazon|2474283100401
https://video-edge-da0548.hou01.abs.hls.ttvnw.net/v1/segment/QtMjDLAw.ts

For all subsequent calls made by the player to obtain an updated variant playlist for the live stream, the variantproxy rewrites the value of EXT-X-TARGETDURATION as 2 seconds as detailed above.

In another embodiment, for Android mobile devices for instance, an HttpInterceptor, which enables HTTP responses from a server to be modified, is set up to handle HTTP responses to the Android ExoPlayer media player 225. When the media player 225 starts to play a stream 228, it makes a REST call to the video origin server 226 to retrieve the Master playlist and the Master playlist is returned to the media player in the REST response. The media player 225 then selects the bitrate variant to play and it makes another REST call to the video origin server 226 to retrieve that bitrate variant's playlist. At this time, the HttpInterceptor on the Android user device 220b intercepts the REST response containing the bitrate variant's playlist file, which has an EXT. X-TARGETDURATION value of 6 seconds and looks like this:

#EXTM3U
#EXT-X-VERSION:3
#EXT-X-TARGETDURATION:6
#EXT-X-MEDIA-SEQUENCE:0
#EXT-X-TWITCH-ELAPSED-SECS:32298.000
#EXT-X-TWITCH-TOTAL-SECS:32304.006
#EXT-X-START:TIME-OFFSET=0.000
#EXT-X-PROGRAM-DATE-TIME:2022-04-28T03:01:13.424Z
#EXTINF:2.002,Amazon|2474283100401
https://video-edge-da0548.hou01.abs.hls.ttvnw.net/v1/segment/C0yMMsD.ts
#EXT-X-PROGRAM-DATE-TIME:2022-04-28T03:01:15.426Z
#EXTINF:2.002,Amazon|2474283100401
https://video-edge-da0548.hou01.abs.hls.ttvnw.net/v1/segment/QtMjDLAw.ts

The HttpInterceptor examines the contents of the bitrate variant's playlist file and if the value of EXT-X-TARGETDURATION is greater than 2 seconds, it rewrites the value of EXT-X-TARGETDURATION as 2 seconds and passes the modified playlist file to the media player:

#EXTM3U
#EXT-X-VERSION:3
#EXT-X-TARGETDURATION:2
#EXT-X-MEDIA-SEQUENCE:0
#EXT-X-TWITCH-ELAPSED-SECS:32298.000
#EXT-X-TWITCH-TOTAL-SECS:32304.006
#EXT-X-START:TIME-OFFSET=0.000
#EXT-X-PROGRAM-DATE-TIME:2022-04-28T03:01:13.424Z
#EXTINF:2.002,Amazon|2474283100401
https://video-edge-da0548.hou01.abs.hls.ttvnw.net/v1/segment/C0yMMsD.ts
#EXT-X-PROGRAM-DATE-TIME:2022-04-28T03:01:15.426Z
#EXTINF:2.002,Amazon|2474283100401
https://video-edge-da0548.hou01.abs.hls.ttvnw.net/v1/segment/QtMjDLAw.ts

For all subsequent calls made by the player to obtain an updated variant playlist for the live stream, the HttpInterceptor rewrites the value of EXT-X-TARGETDURATION as 2 seconds as detailed above.

Embodiments of the present system may also be configured to ameliorate the problem of differences in the TBL of the user devices 220 when attempting to generally synchronize user voting relating to various game events. Specifically, in one implementation each user application 221 is configured hereinafter to determine a TBL for its respective user device 220. As is discussed below, this determination of TBL may be affected by performing computations based upon information included within with one or more files included within the live media stream 228 rendered by the media player 225 (e.g., an HLS media player) within each user application 221. The user applications 221b executed by the user devices 220b receiving a vote signal then calculate a time behind live (“TBL”) of the video stream 228 of the basketball game being played on the game floor 258. In order to provide each user or fan a high-quality experience, it is desired to instantiate the live action voting UI in each user application 221 at the time in the video corresponding to the time the vote was triggered by an event in the venue 230. In order to do this, it is necessary to calculate TBL and then delay the instantiation of the voting UI in the user application 221 by TBL. For example, if the user application 221 determines the user device 220 is operating 5 seconds behind the live video stream 228 (TBL=5), then the user application 221 will delay instantiating the voting user interface for 5 seconds after receiving the vote signal generated by the module 210. Each user application 221 is given vote duration (V) in seconds, where:

$$V - T B L = {V}_{actual}$$

In some embodiments V_{actual} may be set to be somewhat less than V-TBL in order to account for synchronization errors and the like. Once V_{actual} seconds expire, the user device 220 sends the vote received by its user application 221 to the voting module 210. The voting module 210 tabulates the votes; which may be multiplied by some factor on a per user basis based on elements such as a user's Fan IQ holdings, level as determined by Fan IQ, badges held by the user, web3 artifacts such as tokens or NFTs held be the user, etc; received from the user devices 220 of users affiliated with a given team, based on configuration provided by the floor configuration server 214 determines what game object(s)/floor area graphics will be illuminated based on the vote result and sends the information regarding what object(s) to illuminate as well as which object(s) to cease illuminating as a result of the voting to the floor server 236 via the real time communication services 212. Based upon the information passed as a result of the voting the floor server 236 instructs the floor controller 240 to cause game object/floor area graphics associated with the given team to be rendered based upon the vote result. In one embodiment each game object can only be turned on (or lit) once per period unless all the available game objects have been exhausted during a period, in which case all of the objects are reset as unused and can be lit a 2^{nd} time, and so on. For example, once all the available game objects have been exhausted during a game having an Elam ending (i.e., a game having a duration based upon achievement of a target score rather than a time duration), all of the objects may be reset as unused potentially multiple times.

As noted above, it is necessary to first calculate TBL in order to delay the instantiation of the voting UI in the user application 221 by TBL and thereby improve the user experience by synchronizing the voting UI to the associated game event in the video stream being rendered by the application 221. In order to calculate TBL, in one embodiment the value of the EXT-X-PROGRAM-DATE-TIME tag, which indicates the date and time at which a video segment was originally encoded in the venue 230, is determined for the current video segment (.ts file) being played. As discussed above, each media player 225 buffers multiple video segments, so it is necessary to ensure that the EXT-X-PROGRAM-DATE-TIME tag value being determined corresponds to the segment currently being viewed by the fan or other user of the device 220. For user devices 220 configured with iOS, an AVPlayerItemMetadataOutputPushDelegate Delegate is utilized. When the media player 225 plays a new .ts segment, the Delegate gets called and is passed the new metadata for that segment. TBL is computed by calculating the difference between the current date and time on the user device 220 and the date and time at which the current segment was encoded as per the segment's metadata, which contains that segment's EXT-X-PROGRAM-DATE-TIME value, reported by the media player 225. Note that in this embodiment the current time of the user device 220 must be accurate for the calculation to be correct. When the user application 221 receives a signal from the real time communication services module 212 to instantiate a live action vote UI, it then delays for the computed TBL seconds before instantiating the live action UI. In addition, the media player 225 video buffer is tracked using an addPeriodicTimeObserver Observer. When the Observer determines that the video buffer is failing to update, which indicates stalled video playback, it may cause the video player to restart in order to resume video playback.

For user devices 220 configured with Android, a LiveDataObserver Observer is registered on the OnMetaData event emitted by the ExoPlayer media player 225. When the media player 225 plays a new .ts segment, the Observer gets called and extracts the segment timestamp from the metadata passed from the media player 225 to the Observer. TBL is then computed by subtracting the segment timestamp reported by the player 225 from the current time on the user device 220. Note that in this embodiment the current time of the user device 220 must be accurate for the calculation to be correct. When the user application 221 receives a signal from the real time communication services module 212 to instantiate a live action vote UI, it then delays for the computed TBL seconds before instantiating the live action UI.

In some instances, the live video stream 228 provided to a given user device 220 by the video origin server 226 may fall too far behind the game activity occurring on the game floor 258 for a user of the user device 220 to participate in live action voting; that is, TBL for the given user device 220 exceeds a configured value (typically in seconds). This may occur when, for example, network conditions are poor. When TBL exceeds the configured value (which can be dynamically changed), the user of the device 220 is notified through the user application 221 that their stream is too far behind the live game to participate in live action voting. In order to re resynchronize the user device 220 with the live video stream 223 such that the device 220 reflects a smaller TBL, one of two actions may be taken. Specifically, the media player 225 executing on the device 220 may be forced to seek to the most current time buffered by the player 225. Alternatively, the current session with the live stream 228 being provided to the device 220 by the communication services module 212 is terminated and a new live stream 228 session (at a current time) is instead requested by the device. In both cases the media player 225 is effectively caused to jump forward in time with respect to rendering of the live stream 228 and thereby substantially “catch up” with the live game action occurring on the game floor 258.

Attention is now directed to FIG. 9, which illustrates a configuration for determining TBL which may be used in the case of users watching live game action on a second screen device 227 (e.g., a TV or computer) rather than on their user device 220c by utilizing the user application 221c. In the configuration for determining TBL illustrated in FIG. 9, various contextual information has been omitted (e.g., the venue 230) for clarity of presentation. Referring now to FIG. 9, the user can make a designation in the user application 221c indicating that they are watching on a second screen device 227. When this occurs, the user application 221c closes the media player 225, requests access to the user device 220c microphone and then utilizes an Automatic Content Recognition (ACR) module 229 to listen to an audio 222 portion of the live stream 228 playing on the second screen device 227. Periodically based on a configured value, the user application 221c will request an audio fingerprint from the ACR module 229 of the current video being played on the second screen device 227. That audio fingerprint 231 is sent to an ACR server 910 in the cloud 203, which is also receiving the video stream 223 from the video server workflow 224 in the venue 230. The ACR server 910 compares the audio fingerprint 231 to the set of fingerprints it has generated from the video stream 223 and it returns the timestamp (Tₛₑᵣᵥₑᵣ) 233 of its matching audio fingerprint to the user application 221c. The user application 221c then uses the timestamp 233 of the fingerprint 231 from the ACR server 910 and the timestamp of the fingerprint it generated locally on the user device 220c via the ACR module 229 (Tᵤₛₑᵣ) to calculate the TBL. In one embodiment this is the equation used to calculate TBL in the manner illustrated by FIG. 9:

$$T B L = {T}_{user} - {T}_{server}$$

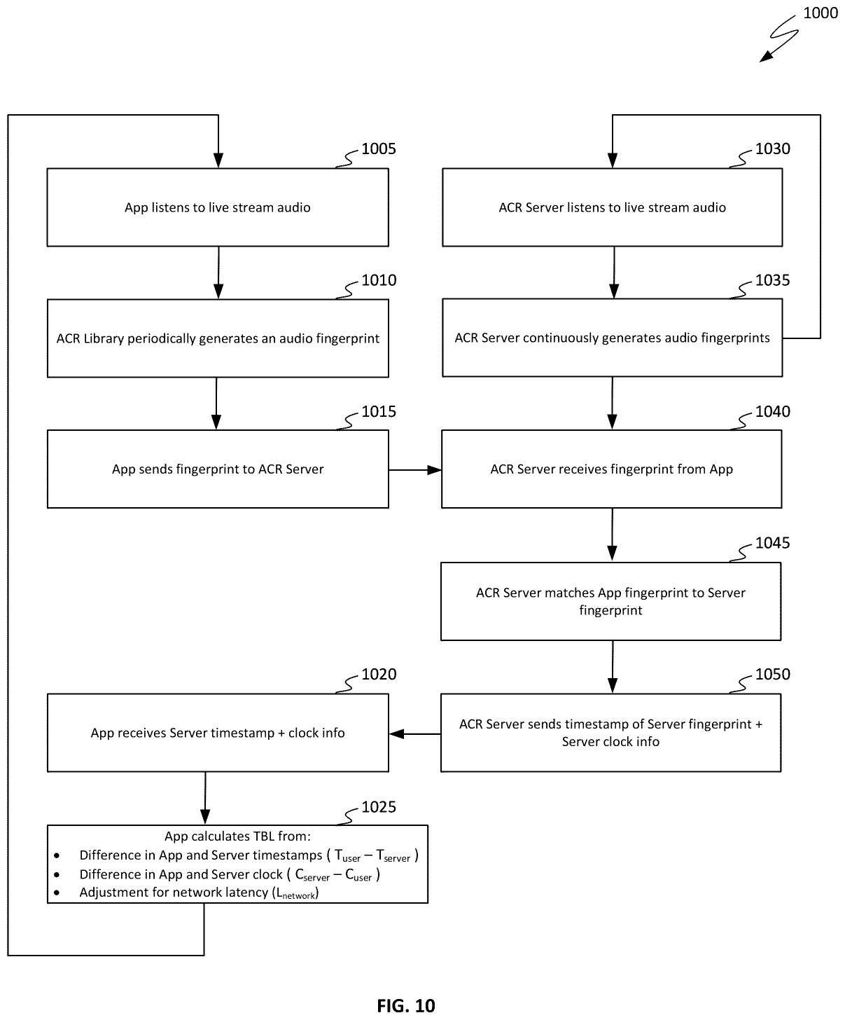

This calculation assumes that the times on both the ACR server and the user device 220c are both synchronized with an accurate time service.
FIG. 10 is a flowchart describing an exemplary method 1000 for determining TBL using the configuration of FIG. 9 in the case in which the clocks on the ACR server 910 and the user device 220c are not synchronized. Given this lack of clock synchronization the method of FIG. 10 utilized an alternative calculation for determining TBL. Specifically, given the clock value of the of a time service (C_{service}) in UTC, the clock value of the ACR server (Cₛₑᵣᵥₑᵣ) in UTC, the clock value of user device 220c (Cᵤₛₑᵣ) in UTC and the network latency of the communication to/from the ACR server and the user device 220c (L_{network}), the following calculation is used to calculate TBL:

$$T B L = ( {T}_{user} + ( {C}_{service} - {C}_{user} ) ) - ( {T}_{server} + {L}_{network} + ( {C}_{service} - {C}_{server} ) )$$

which can be simplified to:

$$T B L = ( {T}_{user} - {T}_{server} ) + ( {C}_{server} - {C}_{user} ) - {L}_{network}$$

Referring to FIG. 10, the method 1000 includes configuring the user application 221c of the user device 220c to listen to live stream audio (stage 1005), An ACR Library within the user device 220c periodically generates an audio fingerprint (stage 1010) and sends this fingerprint to the ACR Server 910 (stage 1015). The ACR Server 910 also listens to live stream audio (stage 1030) and in response continuously generates audio fingerprints (stage 1035). The ACR Server 910 receives the fingerprint from the user application 221c (stage 1040) and matches the fingerprint received from the application 221c to the fingerprint generated by the ACR server 910 (stage 1045). The ACR Server 910 sends the timestamp of the server fingerprint in combination with the clock information of the ACR Server 910 (stage 1050) and this information is received by the user application 221c (stage 1020). The user application 221c then calculates TBL based upon the expression above, i.e., (Tᵤₛₑᵣ−Tₛₑᵣᵥₑᵣ)+ (Cₛₑᵣᵥₑᵣ−Cᵤₛₑᵣ)−L_{network} (stage 1025).

In another embodiment, a platform-independent method of determining TBL using the insertion of SCTE 35 messages into the video stream 233 is utilized. See https://www.scte.org/standards/library/catalog/scte-35-digital-program-insertion-cueing-message/). SCTE 35 message insertion is used to mark midroll advertising breaks in videos. Most, if not all, commercial video encoders recognize a SCTE 35 message in their video stream input and convert it into markers, tags or other format-specific data in the video encoder output. In the case of HLS, a SCTE 35 message can be converted into a set of EXT-X-CUE-OUT, EXT-X-CUE-OUT-CONT and EXT-X-CUE-IN tags that mark an ad break in the bitrate variate playlist. In accordance with the disclosure, the duration data is set in the SCTE 35 message to one second, resulting only in a EXT-X-CUE-OUT tag with a duration of one second and a EXT-X-CUE-IN tag. When the media player 225 in the user application 221b encounters the EXT-X-CUE-OUT in the bitrate variant playlist, it will emit an event for which the user application 221b is listening.

In this SCTE 35-based TBL workflow, an operator in the venue 230 would cause a SCTE 35 message with duration data set to 1 second to be inserted into the video stream 223 at the time that a vote needs to occur. The user applications 221b executed by the user devices 220b receiving a vote signal then waits for the event to be emitted from the media players 225 indicating the detection of an EXT-X-CUE-OUT with a duration of one second in the video stream 228. This EXT-X-CUE-OUT event accurately indicates the TBL for each of the user applications 221b and thereby signals said user applications to instantiate the voting UI immediately upon event detection.

The game environment control platform 202 may be implemented using “cloud” computing capabilities 203. As is known, cloud computing may be characterized as a model for facilitating on-demand network access to a shared pool of configurable computing resources (e.g., networks, servers, storage, databases, applications, and other services) that can be rapidly provisioned and released with minimal management effort or service provider interaction. Cloud systems tend to automatically control resource use by utilizing some form of metering capability with respect to, for example, storage, processing, bandwidth, memory and active user accounts. Various cloud service models are possible, including cloud software as a service (SaaS), cloud platform as a service (PaaS), and cloud infrastructure as a service (IaaS).

Alternatively, the game environment control platform 202 may be implemented by using on-premise servers and other infrastructure rather than by using cloud-based services. Hybrid implementations of the platform including a combination of on-premise and cloud-based infrastructure are also within the scope of the present disclosure.

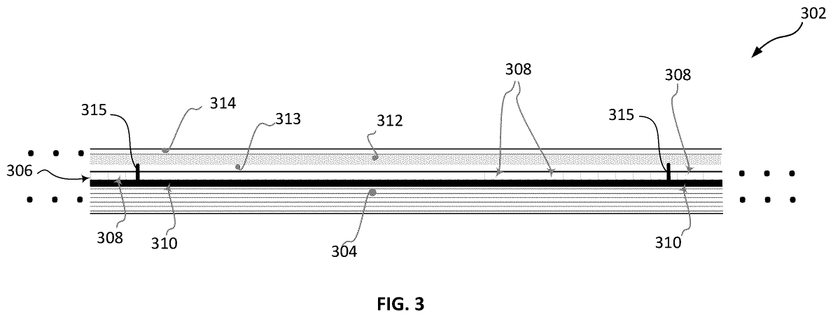

Turning now to FIG. 3, a cross-sectional view is shown of an embodiment of a multi-layer floor 302 of the basketball court 258 as configured with selectively illuminable court areas and markings. As show, the multi-layer floor 302 includes a hardwood layer 304 comprised of hardwood of the type used in conventional flooring for basketball courts. Above the hardwood layer 304 is an LED layer 306 comprised of a matrix of LEDs 308 supported by an LED frame structure 310. The LEDs 308 may be electrically controlled and driven by drive electronics (not shown in FIG. 3) disposed within the LED frame structure 310. A polycarbonate layer 312, which may be on the order of 1 inch thick and have a matte finish, covers the LED layer 306 and is separated from it by an air gap 313. Alternatively, glass instead of polycarbonate may be used to implement layer 312. In one embodiment the polycarbonate layer 312 and the LED layer 306 are partitioned into rectangular sections such that each rectangular section of the polycarbonate layer 312 overlays a corresponding rectangular section of the LED layer 306. An optional top layer 314 of the floor 302 may comprise a substantially transparent adhesive layer of some sort designed to enable shoes worn by the players 261 to grip the surface of the court 258.

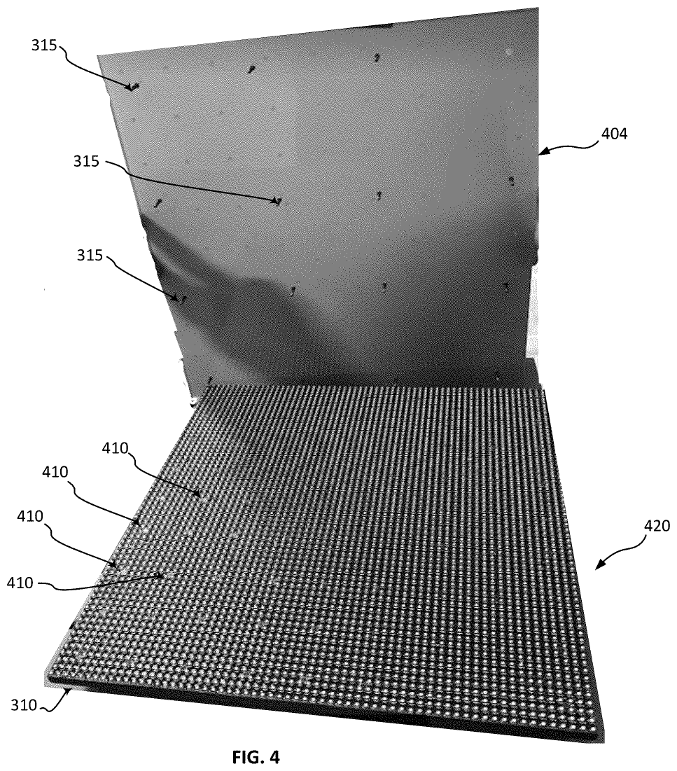

As shown in FIG. 4, in one embodiment each rectangular polycarbonate section 404 of the polycarbonate layer 312 includes a plurality of support posts 315. During assembly of the multi layer floor 302, the support posts 315 of each rectangular polycarbonate section 404 are inserted through holes or apertures 410 between individual LEDs 308 within a corresponding rectangular LED section 420 of the LED layer 306. The posts 315 may be anchored within the LED frame structure 310. This enables each rectangular polycarbonate section 404 of polycarbonate layer 312 to cover the corresponding rectangular LED section 420 of the LED layer 306 but to nonetheless be separated from such rectangular LED section 420 by the air gap 313.

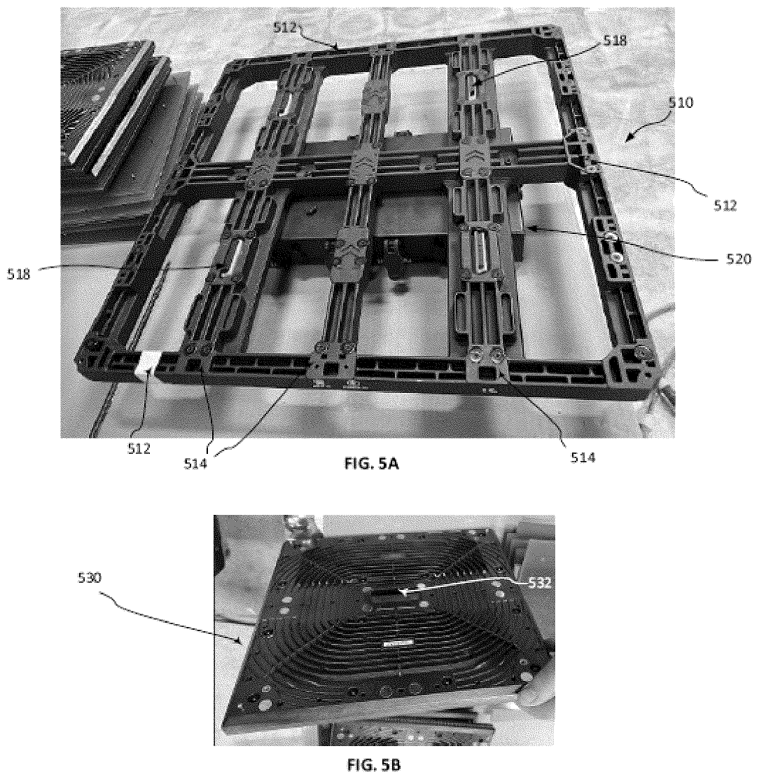

FIGS. 5A and 5B illustrate components included within an exemplary implementation of the LED frame structure 310. Specifically, FIG. 5A is a perspective view of a chassis arrangement 510 included within the LED frame structure 310. The chassis arrangement 510 includes a set of first supporting arms 512 and a set of second supporting arms 514 arranged substantially orthogonal to the first set of supporting arms. As shown, certain of the second set of supporting arms 514 include electrical connectors 518. In one embodiment the chassis arrangement 510 of FIG. 5A may house a set of four 1′×1′ LED tiles 530 (FIG. 5B) as well as the wiring and connectors connecting such tiles to an LED controller. FIG. 5B is a bottom perspective view of an LED tile 530 secured by the chassis arrangement 510. As shown, the LED tile includes a male electrical connector 532 designed to interconnect with one of the female electrical connectors 518 (FIG. 5A) when it is attached to the chassis arrangement 510. In one embodiment each LED drive unit 520 provides power and electrical connections to a corresponding LED tile 530.

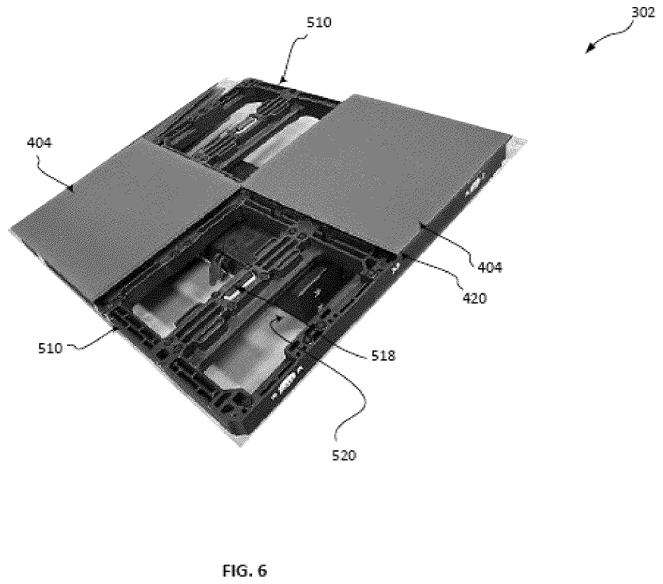

FIG. 6 is a partially disassembled and perspective view of various elements of the multi-layer floor 302. As shown, the chassis arrangement 510 is configured to support rectangular LED sections 420 and corresponding overlying rectangular polycarbonate sections 404. Each rectangular LED section 420 is driven by a corresponding LED drive unit 520 (not shown in FIG. 6), which is connected to a corresponding electrical connector 518.

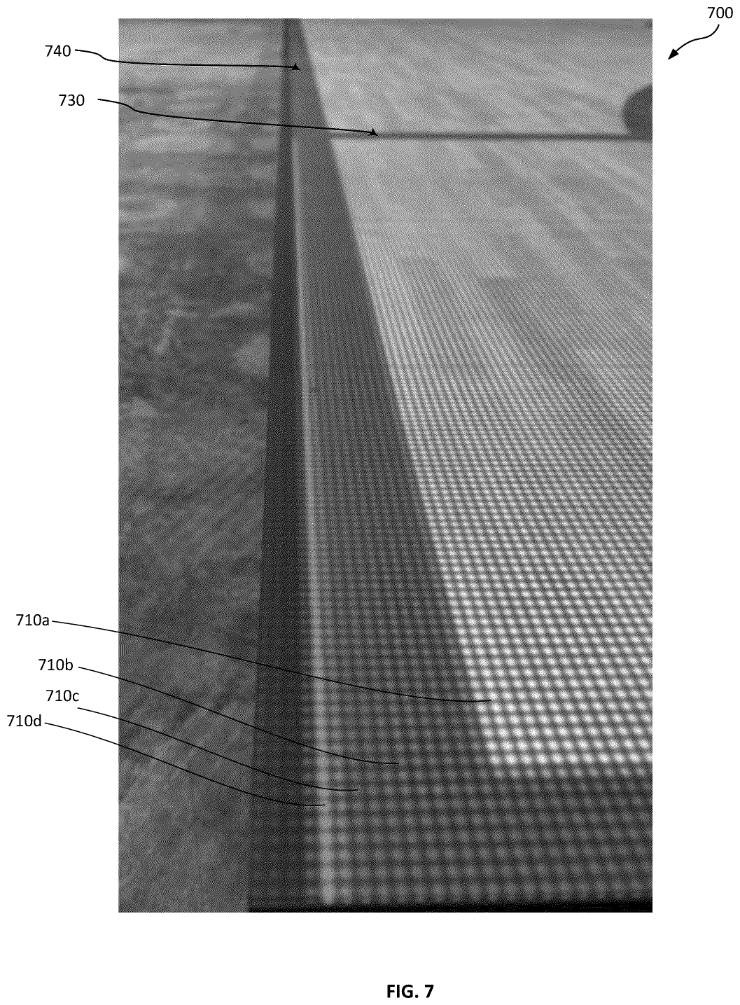

FIG. 7 illustrates a portion of a multi-layer floor 700 when illuminated so as to render an exemplary basketball court. The multi-layer floor 700 may be implemented substantially identically to the multi-layer floor 302 described with reference to FIGS. 3-6. As shown, individual LEDs 710a-d within an LED layer of the multi-layer floor 700 may be driven to a plurality of different colors. Similarly, a group of the LEDs 710 proximate the center of the basketball court may be driven to a color different from the surrounding floorboards to render a half court line 730. A different group of LEDs 710 proximate an edge of the basketball court may similarly be driven to create a court boundary line 740.

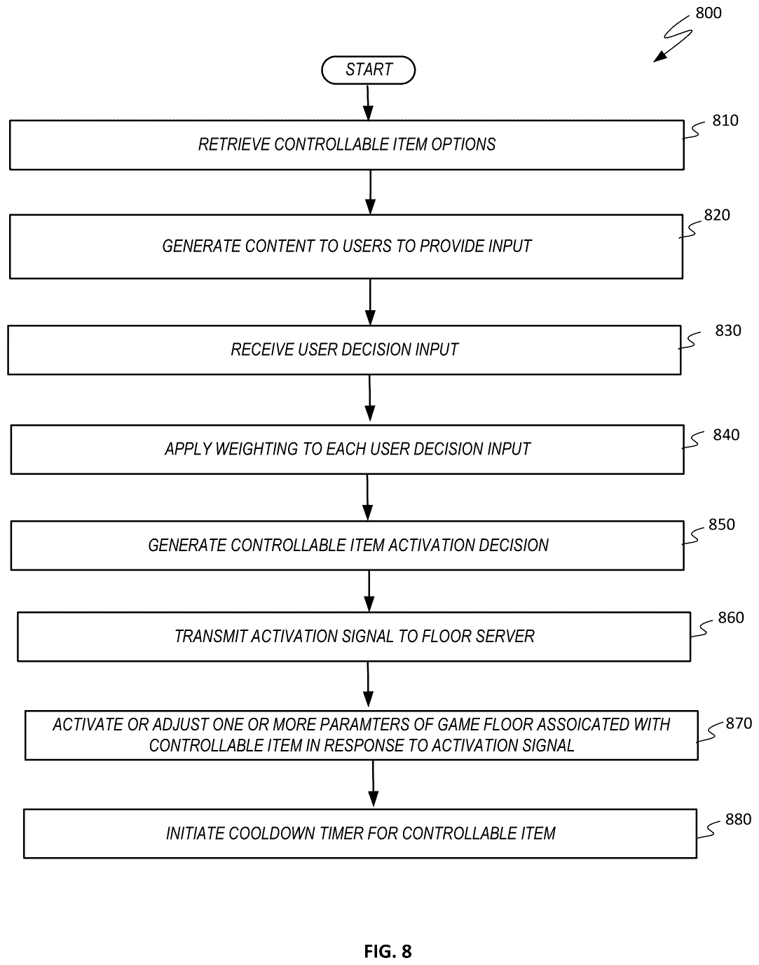

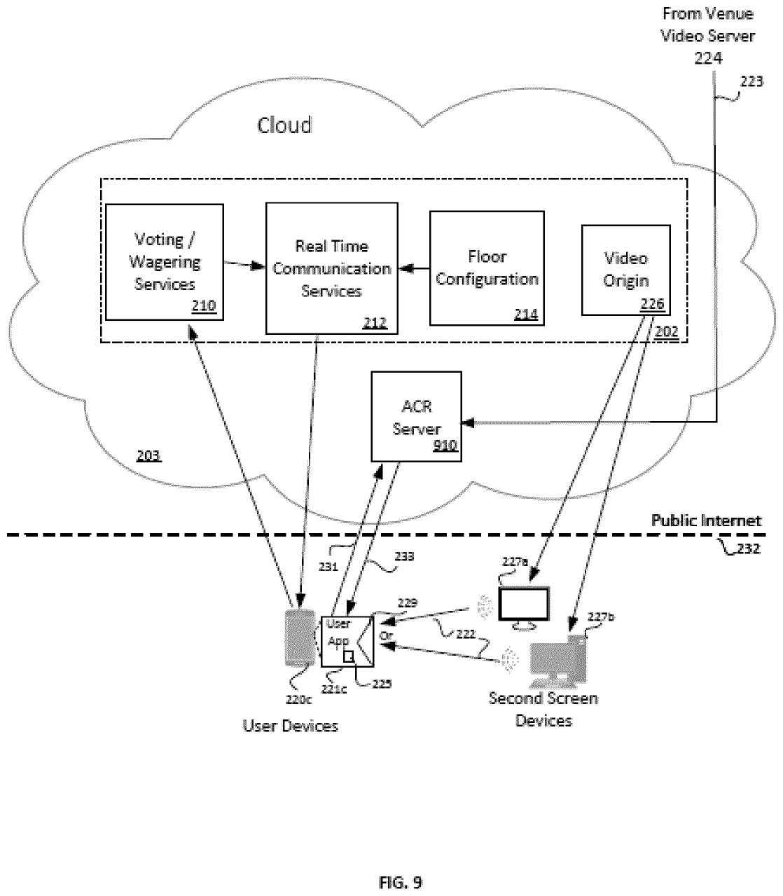

FIG. 8 is a flow chart describing an exemplary method 800, carried out by the game environment control platform 202, for adjusting or activating parameters of the game floor 258 in response to input provided by user devices 220. In what follows the various parameters of the game floor 258 and other elements within the venue 230 which may be activated or adjusted in response to input from the user devices 220 during a live-action sporting event (e.g., a basketball game) may be referred to as “controllable items”, “activation objects” and similar terms. Referring to FIG. 8, the platform 202 retrieves options for controllable item activation for presentation via the user applications 221 of user devices 220 as corresponding activation objects (stage 810). For instance, the platform 202 can select several alternatives for controllable item activation for presentation through the user applications 221 as corresponding activation objects such that the users of user devices 220 can provide their input in selecting one of the activation objects. The selection by the platform 202 of options for controllable item activation can be based on a current situation pertaining to the live-action sporting event being played in the venue 230 (e.g., less than two minutes remaining in the game) and/or by manually triggered operator input.

The voting services module 210 of the control platform 202 generates content (e.g., a user interface to be rendered by a user device 220) for providing a user input for a controllable item activation decision (stage 820). The generated content can be transmitted to user devices 220 by the real time communication services module 212. In one embodiment the generated content is transmitted to user devices 220 of fans or viewers associated with one of two teams participating in the live sporting event being held in the venue 230. The generated content can then be displayed by the user devices 220 for presentation to such fans or viewers associated with a given team.

The real time communication services module 212 receives user votes or other user decision input from each of the user devices 220 of fans or device users associated with the team (stage 830). According to embodiments, each user of a device 220 provides user decision input by selecting one of the activation objects (each corresponding to a controllable item) presented on the user device 220. As discussed above, the voting services module 210 permits users of devices 220 to submit controllable item selections within a given vote duration (V) as modified by a time behind live (TBL); again, the TBL associated with a given user device 220 or second screen device 227 is indicative of the delay experienced by the user device 220 or second screen device 227 in rendering a video stream of the live sporting event taking place within the venue 230. Input submitted during the window of time can be taken into account to generate the controllable item activation decision. Input submitted outside the window of time may be discarded and/or ignored by the voting services module 210.

According to embodiments, the interactive sports management platform 202 applies weighting to each user decision input (stage 840). The platform 202 can retrieve a score or a rank of each of the users associated with the team and can be configured to weigh each user's decision input based on the corresponding score or user ranking. For instance, the platform 202 can multiply each user input by a weighting factor to take into account the score or ranking of each user. Subsequently, the interactive sports management platform 202 generates a controllable item activation decision (stage 850) and transmits a corresponding control signal or instruction to the floor server (stage 860). One or more parameters of the game floor 258 associated with the controllable item (e.g., a bonus area 268) are then activated or adjusted in response to the activation signal during the live sporting event (stage 870). In one embodiment a cooldown timer associated with each controllable item is initiated once the controllable item has been activated in response to an activation decision, thereby precluding reactivation of the controllable item until after expiration of the cooldown timer (880).

As mentioned above, activation of controllable items may affect parameters of the live sporting event being played on the game floor 258. For example, when the controllable item in question corresponds to a bonus area 268, activation of the controllable item results in illumination of the bonus area and/or a boundary thereof and, typically, the awarding of a greater number of points for shots from within the bonus area 268. When a controllable item corresponds to a player 261, the LED layer 306 may alter the projected illumination pattern so as to create a graphic which “follows” movement of the player 261 across the game floor 258. Activation of a controllable item corresponding to a player 261 may, for example, result in a greater number of points being awarded to the team of the player 261 than when shots are made by other players on the team. When a controllable item corresponds to a ball 262, the LED layer 306 may alter the projected illumination pattern so as to create a graphic which “follows” movement of the ball 262 across the game floor 258. Activation of a controllable item corresponding to a player 262 may, for example, result in a greater number of points being awarded to the team than when shots are made when the ball is activated.

It may be appreciated that the game floor or playing surface 108 may be illuminated in a variety of ways under the control of the controller infrastructure 110 in accordance with the disclosed embodiments. For example, in general terms the illumination elements within the game floor or playing surface 108 may be controlled to display movies, graphics and textual content. Movies can, for example, be rendered in a full screen, on one side of the game floor 108 or on the game floor 108 within clipping windows of arbitrary shape and location. Such movies or other video content may be game-related, sponsored, or comprise advertisements and may be triggered by either events in the game or manually by an operator.

Graphical content can be rendered by the illumination elements within the game floor or playing surface 108 in static or dynamic form. As mentioned above, graphical content rendered by the illumination elements of the playing surface 108 can track a game object or players, may be driven by an algorithm or artificial intelligence, or controlled by fans or viewers via their respective user devices 120, generally without polling. Graphics rendered through the playing surface 108 can be accompanied by audio and may be coordinated and synchronized with other display screens in the venue, including a screen associated with backboards in the case of a playing surface 108 configured for basketball. Single or cumulative game events occurring during the live sporting event can trigger the rendering of graphics by the playing surface 108 or by other displays within the venue 104. In one embodiment non-voting user gestures made with respect to their respective user devices 120 can trigger the display of graphics by the playing surface 108.

Textual content rendered through the playing surface 108 may include, for example, player statistics displayed at a static location or at a series of locations which “follow” a player moving on the playing surface. Game and team statistics may also be rendered through the playing surface. Other game status information (e.g., score, period, etc.) may also be rendered statically or dynamically through the playing surface 108.

In the case of a playing surface 108 configured to include an ice rink for supporting play of ice hockey, the location of players and a hockey puck within the rink may be tracked through RF tagging or other means as described herein. Graphics rendered by the playing surface 108 may then be changed based upon the velocity and/or position of the hockey players and/or hockey puck. Similar to the case of basketball, arbitrary regions within the rink may be lighted by illumination elements within the playing surface and/or portions of the rink proximate or trailing tracked players may also be illuminated. Various statistics associated with tracking of the puck (e.g., possession, passes, shots, steals) may also be rendered by control of the illumination elements within the playing surface 108.

Of course, the playing surface 108 may configured to accommodate the playing of other sports as well. For example, the playing surface 108 include a defined field area for supporting play of futsal. The location of players and a ball within the field area may be tracked through RF tagging or other means as described herein. Graphics rendered by the playing surface 108 may then be changed based upon the velocity and/or position of the futsal players and/or ball. Similar to the case of basketball, arbitrary regions within the field area may be lighted by illumination elements within the playing surface 108 and/or portions of the field area proximate or trailing tracked players may also be illuminated. Various statistics associated with tracking of the ball (e.g., goals, shots, team in possession) may also be rendered by control of the illumination elements within the playing surface 108.

In various embodiments the voting/wagering module 210 facilitates real-time or other wagering by viewers of the live sporting event. Such wagering may be with respect to, for example, the outcome of game plays executed during the sporting event, the occurrence of predefined events during the sporting event, and the game performance of selected players. For example, in the case of basketball certain users may place wagers via their respective user applications 221 with regard to a certain type of shot being made (e.g., a 3-point shot, a slam dunk, etc.) or certain thresholds/goals being reached (team/player scores P points, player earns a double-double/triple-double, team holds opponent to less than P points, etc). Other wagers may be placed by users via their user applications 221 with regard to the occurrence of future events during a predefined time frame within the game (e.g., a steal or other turnover being made, a particular type of foul being called, etc.). In various embodiments such wagering may be made using fiat currency, tokens, or via a point system connected to various incentives or rewards.

The illustrative embodiments described herein can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more specialized processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), User Datagram Protocol (UDP), Transmission Control Protocol (TCP), Voice over IP (VOIP), a Peer-to-Peer (P2P) protocol, Hypertext Transfer Protocol (HTTP), Hypertext Transfer Protocol Secure (HTTPS), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), a game console, a head mounted display (HMD) device and/or other communication devices. The browser device includes, for example, a computer (e.g., desktop computer and/or laptop computer) with a World Wide Web browser (e.g., Chrome™ from Google, Inc., Microsoft® Edge® available from Microsoft Corporation, Safari from Apple Corporation, and/or Mozilla® Firefox available from Mozilla Corporation). Mobile computing device include, for example, a Blackberry® from Research in Motion, an iPhone® or iPad® from Apple Corporation, and/or an Android™-based device. IP phones include, for example, a Cisco® Unified IP Phone 7985G and/or a Cisco® Unified Wireless Phone 7920 available from Cisco Systems, Inc. Game consoles include, for example, an Xbox™ Series X from Microsoft®, a Playstation® 5 from Sony and/or a Nintendo Switch from Nintendo®. HMDs include, for example, a Meta Quest 3 from Meta, a VIVE XR Elite from HTC, a HoloLens from Microsoft® and/or a MagicLeap 2 from MagicLeap.

Comprise, include, and/or plural forms of each are open ended and include the listed parts and can include additional parts that are not listed. And/or is open ended and includes one or more of the listed parts and combinations of the listed parts.

One skilled in the art will realize the technology may be embodied in other specific forms without departing from the spirit or essential characteristics thereof. The foregoing embodiments are therefore to be considered in all respects illustrative rather than limiting of the technology described herein.

What is claimed is:

1. A system, comprising:
a multi-layer structure having a playing surface upon which a plurality of players participate in a sporting event, the multi-layer structure including an arrangement of illumination elements configured to controllably emit light, the arrangement of illumination elements being separated by a gap from a substantially transparent layer supporting the playing surface;
a player tracking subsystem including a plurality of sensors configured to provide detection signals useable to track locations of one or more of the plurality of players relative to the playing surface; and
a control subsystem configured to control operation of the arrangement of illumination elements responsive to the locations of the one or more of the plurality players and to gain status information relating to the sporting event.

2. The system of claim 1 wherein the control subsystem includes a game environment control platform and a floor controller wherein the floor controller is electrically connected to the arrangement of illumination elements, the game environment control platform being configured to execute computer readable instructions to: (i) receive user voting information from a plurality of user devices, (ii) generate illumination control instructions in response to one or more of the user voting information, the game status information and the locations of the one or more of the plurality players, and (iii) send the illumination control instructions to the floor controller;
wherein the floor controller is configured to control light emission by the plurality of illumination elements in response to the control instructions.

3. The system of claim 2 wherein the game environment control platform is further configured to provide voting timing signals to the plurality of user devices wherein each of the user devices include a media player for rendering a video stream of the live sporting event and wherein each of the user devices is operative to instantiate a voting user interface in response to one of the voting timing signals, the voting user interface being arranged to permit a user to enter a vote with respect to a game event occurring in the live sporting event.

4. The system of claim 3 wherein each user device is configured to calculate a time behind live (TBL) of the video stream rendered by the user device and to delay, based upon the calculated TBL, instantiation of the voting user interface.

5. The system of claim 2 wherein the illumination control instructions indicate that portions of the playing surface proximate a first of the plurality of players are to be illuminated by ones of the illumination elements.

6. The system of claim 2 wherein the illumination control instructions indicate that at least one area of the playing surface is to be illuminated for a defined duration.

7. The system of claim 2 wherein the game environment control platform is further configured to execute the computer readable instructions to initiate a cooldown timer after generating the illumination control instructions indicating that at least one area of the playing surface is to be illuminated and to refrain from sending additional illumination control instructions identifying another area of the playing surface for illumination until after expiration of the cooldown timer.

8. A system for use with a multi-layer structure having a playing surface upon which a plurality of players participate in a sporting event, the multi-layer structure including an arrangement of illumination elements configured to controllably emit light, the arrangement of illumination elements being separated by a gap from a substantially transparent layer supporting the playing surface, the system comprising:
a player tracking subsystem including a plurality of sensors configured to provide detection signals useable to track locations of one or more of the plurality of players relative to the playing surface; and
a control subsystem configured to control operation of the arrangement of illumination elements responsive to the locations of the one or more of the plurality players and to game status information relating to the sporting event.

9. The system of claim 8 wherein the control subsystem includes a game environment control platform and a floor controller wherein the floor controller is electrically connected to the arrangement of illumination elements, the game environment control platform being configured to execute computer readable instructions to: (i) receive user voting information from a plurality of user devices, (ii) generate illumination control instructions in response to one or more of the user voting information, the game status information and the locations of the one or more of the plurality players or game elements, and (iii) send the illumination control instructions to the floor controller;
wherein the floor controller is configured to control light emission by the plurality of illumination elements in response to the control instructions.

10. The system of claim 9 wherein the game environment control platform is further configured to provide voting timing signals to the plurality of user devices wherein each of the user devices is operative to instantiate a voting user interface in response to one of the voting timing signals, the voting user interface being arranged to permit a user to enter a vote with respect to a game event occurring in the live sporting event.

11. The system of claim 10 wherein each of the user devices includes a media player for rendering a video stream of the live sporting event and wherein each user device is configured to calculate a time behind live (TBL) of the video stream rendered by the user device and to delay, based upon the calculated TBL, instantiation of the voting user interface.

12. The system of claim 9 wherein the illumination control instructions indicate that portions of the playing surface proximate a first of the plurality of players are to be illuminated by ones of the illumination elements.

13. The system of claim 9 wherein the illumination control instructions indicate that at least one area of the playing surface is to be illuminated for a defined duration.

14. The system of claim 9 wherein the game environment control platform is further configured to execute the computer readable instructions to initiate a cooldown timer after generating the illumination control instructions indicating that at least one area of the playing surface is to be illuminated and to refrain from sending additional illumination control instructions identifying another area of the playing surface for illumination until after expiration of the cooldown timer.

15. The system of claim 8 wherein the control subsystem is further configured to control operation of the arrangement of illumination elements in order to cause display of one or more of: video content, 2D/3D animations, game statistics and player statistics.

16. The system of claim 10 wherein a first user of at least a first user device of the user devices is disposed to view a live stream of the live sporting event on a second screen device different from the first user device, the system further including an automatic content recognition (ACR) server configured to (i) receive the video stream, (ii) generate a set of server-resident audio fingerprints corresponding to points in time in the video stream (iii) receive a first audio fingerprint from the first user device, (iv) compare the first audio fingerprint to the set of server-resident audio fingerprints, and (v) return a timestamp of a matching audio fingerprint within the set of server-resident audio fingerprints to the first user device;
wherein the first user device includes a user application configured to use the timestamp of the matching audio fingerprint and a timestamp of the first audio fingerprint to calculate a time behind live of the video stream received by the first user device.
